(19) United States
(12) Patent Application Publication
(10) Pub. No.: US 2003/0158906 A1
(43) Pub. Date: Aug. 21, 2003

(54) Selective offloading of protocol processing

(76) Inventor: John W. Hayes, Los Gatos, CA (US)

Correspondence Address: Giaccherini, Post Office Box 1146, Carmel Valley, CA, 93924, US

(21) Appl. No.: 10/299,104

(22) Filed: Nov. 18, 2002

Related U.S. Application Data
(63) Continuation-in-part of application No. 09/946,144, filed on Sep. 4, 2001.

(51) Int. Cl. G06F 15/16

(52) U.S. Cl. 709/211

(57) ABSTRACT

The present invention provides methods and apparatus for delivering selective offloading of protocol processing from a host computer (12) to an offloading auxiliary processor (132). Selective offloading of protocol processing enables a host (12) to offload the most computationally intensive, memory bandwidth intensive and performance critical portions of the protocol processing task to an auxiliary processor (132) without requiring the auxiliary processor (132) to perform the full suite of functions necessary to perform a complete protocol processing offload. This capability enables the offloading auxiliary processor to be built with fewer resources, and thus more inexpensively. The offloading host will only offload the portions of the protocol processing task that the auxiliary processor can process. If the auxiliary processor is requested to perform an action that it is unable to perform, for any reason, is simply returns the request back to the host computer. The request may be partially completed or not completed at all. This allows “fastpath” functions to be offloaded while more complex, but slower functions such as error handling, resequencing and lost packet recovery and retransmission to be handled by the host computer (12).

### CROSS-REFERENCE TO A PENDING U.S. PATENT APPLICATION & CLAIM FOR PRIORITY

The present patent application is a Continuation-in-Part Application. The Applicant hereby claims the benefit of priority under Sections 119 & 120 for any subject matter which is commonly disclosed in the pending parent U.S. Ser. No. 09/946,144, entitled Selective Offloading of Protocol Processing, filed on 4 September 2001.

### FEDERALLY SPONSORED RESEARCH OR DEVELOPMENT

None.

### FIELD OF THE INVENTION

The present invention pertains to methods and apparatus for delegating computing resources and tasks in a network. In one embodiment of the invention, selected portions of a protocol processing task are dynamically offloaded to an auxiliary processor. Memory bandwidth or CPU processing intensive tasks are then performed by the auxiliary processor to reduce the memory bandwidth or host CPU processing cycles consumed by the performing the protocol processing task. More particularly, one preferred embodiment of the invention enables the offloading auxiliary processor to deposit incoming user data directly into the user's memory space, bypassing the placing of a copy of the data into the operating system's memory and thereby reducing the number of times the received data is copied, enabling a zero-copy architecture. In another preferred embodiment, the invention enables the offloading auxiliary processor to transfer protocol processing back to the host CPU in the event of errors, low resources or other events that are not considered routine for the auxiliary processor to perform. This capability allows one preferred embodiment to have less processing power or memory resources in the auxiliary processor and still perform the mainline or “fastpath” code efficiently without being burdened by having to maintain the slower and much more complex error handling and recovery routines which are them implemented back on the host CPU. The present invention also includes a filtering function which enables the network interface to select between a plurality of protocol processing functions, which although they may perform the same protocol processing tasks, differ in how the tasks are distributed between the host CPU and an offloading auxiliary processor.

### BACKGROUND OF THE INVENTION

Over the past several years the portion of a computer's CPU cycles that are spent performing communications and protocol processing tasks have increased to keep up with the greater bandwidth provided by new networking technologies, most notably 100 megabit (Mb) and gigabit (Gb) Ethernet. As the demands for more CPU cycles to process the networking protocol traffic has increased, several strategies have emerged to mitigate this increase and are based upon optimizing specific functions of the most widely used protocol for computer networking, TCP/IP (Transmission Control Protocol/Internet Protocol). The standard accepted strategies all offload specific, fixed functions of this protocol, specifically performing the calculations of the TCP and IP checksums, or have focused on reducing the number of times the network interface card (NIC) interrupts the host computer. Both of these strategies have been used successfully together to reduce the overall protocol processing load on the host computer, but neither strategy offloads the data movement and reassembly functions of the protocol. Other strategies have focused on putting the entire networking protocol stack implementation on an offloading auxiliary processor to completely offload the host operating system of the protocol processing task. While this may work for a limited set of applications, it requires a costly auxiliary processor with a large memory capacity and complicated interactions with the host computer.

None of the above solutions provides a dynamic mechanism to offload portions of a data stream's network protocol processing on a transactional or on a single event basis. The development of such a system would constitute a major technological advance, and would satisfy long felt needs and aspirations in both the computer networking and computer server industries.

### SUMMARY OF THE INVENTION

The present invention provides methods and apparatus for delivering selective offloading of protocol processing from a host computer to an offloading auxiliary processor. Selective offloading of protocol processing enables a host to offload the most computationally intensive, memory bandwidth intensive and performance critical portions of the protocol processing task to an auxiliary processor without requiring the auxiliary processor to perform the full suite of functions necessary to perform a complete protocol processing offload. This capability enables the offloading auxiliary processor to be built with fewer resources, and thus more inexpensively. The offloading host will only offload the portions of the protocol processing task that the auxiliary processor can process. If the auxiliary processor is requested to perform an action that it is unable to perform, for any reason, is simply returns the request back to the host computer. The request may be partially completed or not completed at all. This allows “fastpath” functions to be offloaded while more complex, but slower functions such as error handling, resequencing and lost packet recovery and retransmission to be handled by the host computer. This also allows an auxiliary processor to be built with limited resources that allows it to offload only a specific number of tasks. When the host computer exceeds the capabilities of the auxiliary processor, the additional tasks are performed on the host computer. This enables the development of inexpensive auxiliary processors to accelerate protocol processing in computing environments that would otherwise not be served by protocol accelerating technology.

Each protocol processing task is offloaded individually, with the host computer regaining control at the end of each protocol processing task or sequence of tasks. This allows the auxiliary processor to maintain only the state information pertinent to the tasks that the auxiliary processor is currently performing. While the host regains control at the end of each task, multiple tasks and sequences of tasks may be chained together to minimize the need to resynchronize state information with the host computer. When making an offload request, the host computer includes information regarding the protocol to be offloaded. It is expected that the protocol will be a combination of protocols including the network protocol, the transport protocol and the application protocol. It can be any protocol or set of protocols in the seven layer ISO protocol reference model. When multiple protocols of different layers are taken together, each unique combination of protocols is treated as a separate protocol. This allows the underlying protocols to be tailored to the requirements of the application and the application protocol. One preferred embodiment of this is iSCSI (internet SCSI) over TCP/IP. Another preferred embodiment is VIA (Virtual Interface Architecture) over TCP/IP.

Methods of constructing the auxiliary processor include adding network processors and memory to a NIC, adding network processors, memory and hardware state machines to a NIC or by adding hardware state machines and memory to a NIC. Additionally, in place of a NIC, this functionality can be placed on the main processor board or “motherboard” of the host computer, or embedded within the I/O subsystem.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIGS. 1 & 2 provide illustrations which help explain the basic concepts comprising the present invention.

FIG. 3 is an illustration which shows the relationship between computers C, a computer network E, a network router R, a network switch S and a network attached storage system D.

FIG. 4 is an illustration which shows the relationship between a computer C and an associated user U, a computer network E, and a network attached storage system D.

FIG. 5 is an illustration which shows Internet Protocol (IP) header.

FIG. 6 is an illustration which shows the Transmission Control Protocol (TCP) header.

FIG. 7 is an illustration which shows the relationship between the network interface NIC, the computer network E and other primary components of a computer C including the central processor CPU, the memory controller MC and the memory M.

FIG. 8 is an illustration of a classical architectural model of host based protocol processing function.

FIG. 9 is an illustration of a full protocol processing offload model.

FIG. 10 is a schematic illustration of the invention.

FIG. 11 is flow chart of a basic embodiment of a selective offloading protocol process.

FIG. 12 is detailed flow chart of a selective offloading protocol process.

FIG. 13 shows selective offloading of a protocol process to a host network interface device driver function within a selective protocol offloading system.

FIG. 14 shows selective offloading of a protocol process to a host resident offload protocol device driver function within a selective protocol offloading system.

FIG. 15 shows selective offloading of a protocol process to an AP resident offload protocol device driver function within a selective protocol offloading system.

### A DETAILED DESCRIPTION OF PREFERRED & ALTERNATIVE EMBODIMENTS

I. Background of the Invention

On any given day, millions upon millions of computers connect to the Internet to convey or to obtain information. A person using a personal computer who wants to connect to another computer to send e-mail or to look at a webpage generally uses a device called a modem to connect an “Internet Service Provider.” The computer at the ISP then conveys messages or webpages from other computers that may be located in far-off places around the world.

When a person requests a page from a website, a request is first sent to the remote computer which “hosts” the website. This request contains specific information about how the content is to be transported from the host computer to the ISP, and then finally to the person requesting the information. Much of this initial request pertains to a determination of the “application protocol” that will be used to convey information from the host computer to the user's computer. A protocol is a predetermined standard or agreement that establishes the rules of exchange between or among computers. For example, when motorists all stop at a red “STOP” signs when they reach an intersection, they are obeying a protocol or rule that has been established to ensure a safe flow of traffic.

The Internet generally runs on a protocol called “TCP/IP,” which stands for Transmission Control Protocol/Internet. Actually, TCP/IP includes two protocols, TCP and IP. In general, most simple transactions that use the Internet are governed by TCP/IP. An example of an application protocol utilized by the present invention is called “iSCSI.” In general, iSCSI is Internet SCSI (Small Computer System Interface) is an application layer Internet Protocol networking standard for linking data storage facilities. By carrying SCSI commands over IP networks, iSCSI is used to facilitate data transfers over intranets, and to manage storage over long distances. The iSCSI protocol is among the key technologies expected to help bring about rapid development of the storage area network (SAN) market, by increasing the capabilities and performance of storage data transmission. Because of the ubiquity of IP networks, iSCSI can be used to transmit data over local area networks (LANs), wide area networks (WANs), or the Internet and can enable location-independent data storage and retrieval.

When many users try to download the same webpage at the same time, some users experience delays in receiving information, because the computer that stores the webpage is unable to handle so many requests simultaneously. Every computer that hosts a webpage has a limited amount of hardware, software and storage space, and, as a consequence, a limited amount processing capacity that is available for fulfilling requests for information, files or images from users. User requests are conveyed to a host computer over the Internet. Once they arrive at the host, they are generally answered in order, and the host processes each request and sends back a reply to each user.

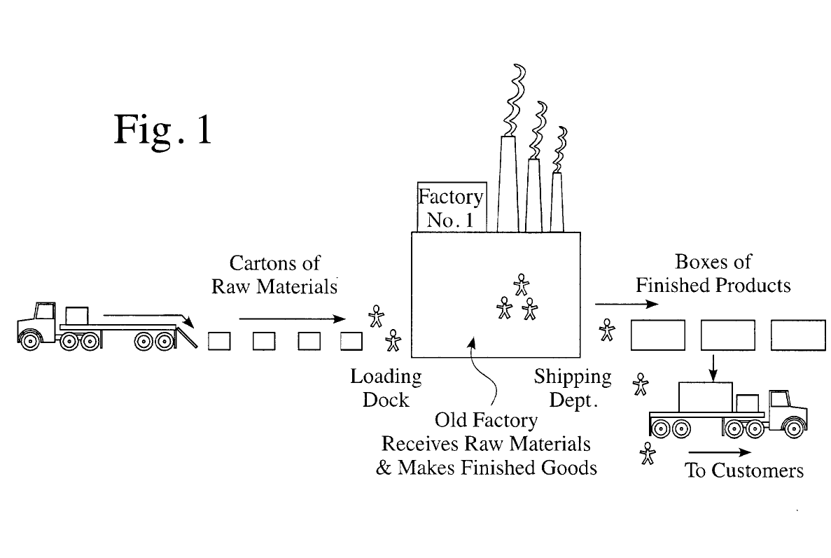

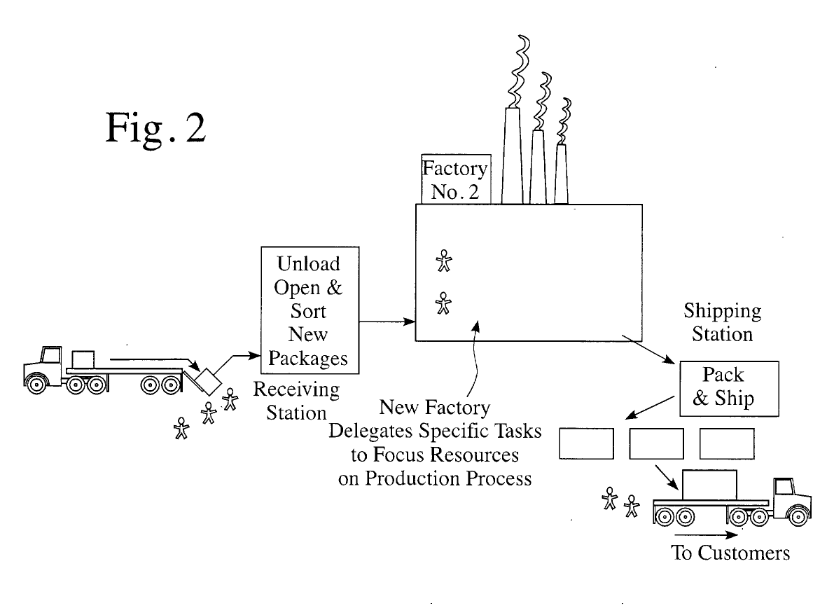

A simple analogy can help to explain the process furnishing content from a host computer to many personal computer users over a network. Consider the factory depicted in FIG. 1. Raw materials arrive at the loading dock, where they are unloaded, unpacked and sorted. Finished goods are then produced inside the single factory building, and are then packed and shipped to customers.

Compare the conventional approach illustrated in FIG. 1 to a more modern factory, which is portrayed in FIG. 2. Factory No. 2 is more efficient than Factory No. 1, because specific functions and processes that are required to fulfill customer requests have been delegated to particular, specialized work sites outside the main factory. As shown in FIG. 2, the job of unloading, opening and sorting cartons of raw materials as they arrive from suppliers is now performed by a separate “Receiving Station” which is equipped with customized tools and specially skilled workers who are focused just on the initial tasks of unloading, opening and sorting small cartons of raw materials. In addition, FIG. 2 also reveals a “Shipping Station” on the opposite side of the manufacturing facility. Like their counterparts at the other end of the operation, the workers at the Shipping Station have their own customized equipment and skills that are designed to empower them to fulfill their designated packing and shipping duties.

In Factory No. 1, all the resources of the factory are utilized to accomplish all the steps needed to fulfill requests from many users.

Factory No. 2, which employs the concepts of division of labor, delegation of tightly-defined work functions, and outsourcing, produces more products using the same set of resources. This is true because the delegation of certain tasks to workers outside the main plant frees up workers, equipment and other resources inside the big building to concentrate on what they do best-manufacturing the product that the customer has ordered. The people in the Receiving and Shipping Stations support this effort by doing their own limited jobs well, and keeping the stream of large boxes of finished merchandise flowing to happy customers.

In this analogy, the small cartons of raw materials delivered to the factories are somewhat like the requests for webpages generated by computer users connected to a network like the Internet. The factories resemble a host computer that stores web pages that users would like to view or download. The large boxes of finished goods leaving a factory represent the content that is dispatched over the network back to the origin of a request.

Factories built of bricks and mortar function best when resources are deployed efficiently. The efficient deployment of resources results in the efficient production of goods. Just like factories built of bricks and mortar, computer networks work better when resources are utilized efficiently.

In the present invention, particular functions are removed from the primary computing system, which comprises both hardware and software. These functions are re-assigned to supporting hardware software, which are specially configured to perform sharply defined and limited tasks. The outsourcing of precisely segmented computing capabilities frees up resources in the primary hardware and software, and enhances the entire system. As a result, more users are cared for at a higher level of service employing the same set of hardware and software assets.

Specifically, the present invention furnishes a solution for augmenting the service capacity of a host in a network. A set of protocol processing tasks, which are normally furnished by the host, are generally delegated to auxiliary processor. These protocol processing tasks generally involve interpreting the requests for data as they arrive from many users. This new auxiliary processor supports the efforts of the primary hardware and software within the host computer, and may take the form of a new “card” or “blade” that sits on the motherboard of the host computer. Just like the owner of a personal computer can insert a new hardware component like a network, printer or port adapter into the main motherboard of his or her computer, the new invention offers a way to augment the host computer to make it work better. In another embodiment, the new auxiliary processor may be reduced to an application-specific integrated circuit (ASIC) or some other chip which is added to the host computer.

II. Overview of the Invention

The present invention provides methods and apparatus for selective offloading of protocol processing from a host CPU to an offloading auxiliary processor. In one preferred embodiment of the invention, the auxiliary processor offloads the reception of iSCSI data over the TCP/IP network protocol, performing all necessary TCP/IP functions that occur during the normal course of a TCP/IP receive operation and all necessary iSCSI data movement functions. In the event of an error or other exceptional condition, the auxiliary processor transfers control back to the offloading host to handle the condition.

In another preferred embodiment of the invention, the auxiliary processor offloads the transmission of “iSCSI” data over the TCP/IP network protocol, performing all necessary TCP/IP functions that occur during the normal course of a TCP/IP transmit operation and all necessary iSCSI data movement functions. In the event of an error or other exceptional condition, the auxiliary processor transfers control back to the offloading host to handle the condition.

In other preferred embodiments, other tasks and sequences of tasks may be offloaded to the auxiliary processor. The tasks and sequences of tasks are described in further detail below.

In other preferred embodiments, other network protocols, transport protocols and application protocols may be offloaded to the auxiliary processor. The protocol may be a combination of protocols including the network protocol, the transport protocol and the application protocol. The offloaded protocols can be any protocol or set of protocols in the seven layer ISO protocol reference model. This protocol may be identical to one of the set of protocols in the seven layer ISO set, or may be a variation, which, while not identical, is generally logically consistent with one of the original seven layer ISO protocols. Examples of this include IP and TCP, which correspond to layers three and four, respectively. When multiple protocols of different layers are taken together, each unique combination of protocols is treated as a separate protocol. This capability allows the underlying protocols to be tailored to the requirements of the application and the application protocol. The additional protocols are described below in the following sections.

III. Preferred & Alternative Embodiments

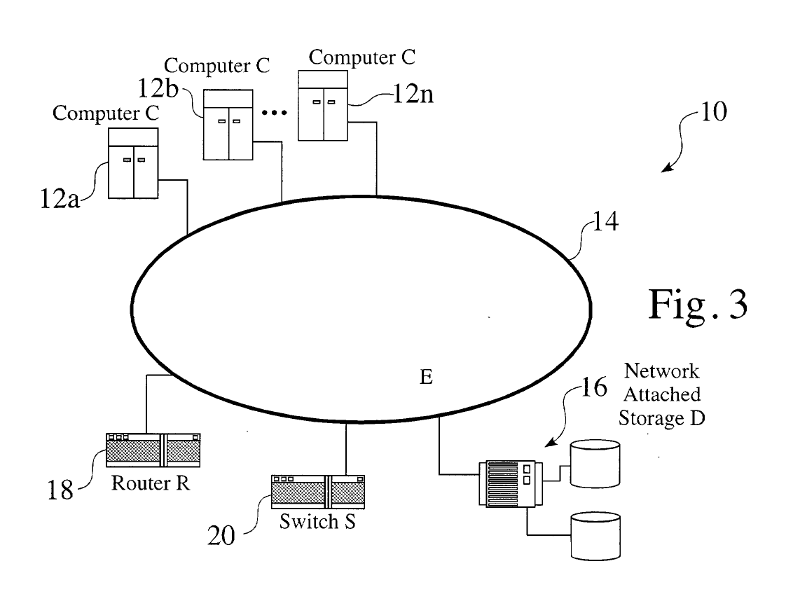

FIG. 3 generally illustrates the embodiments of a computer network 10 to which the present invention pertains as Selective Offloading of Protocol Processing from computers 12a-12n. A computer 12a is attached to the computer network 14. The computer 12 is capable is communicating with other network routers 18, network switches 20, network storage devices 16, and other computers 12, such as computers 12b-12n.

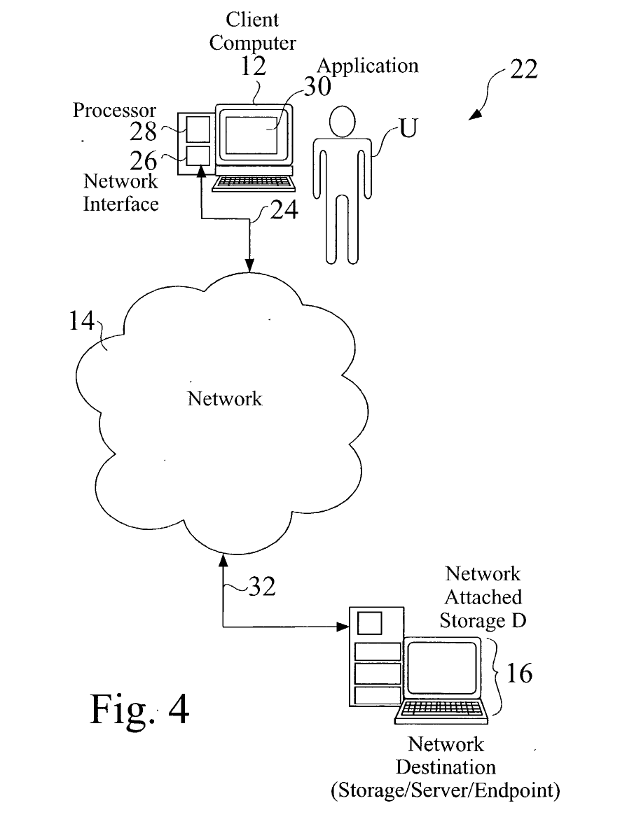

FIG. 4 is an illustration 22 which shows the relationship between a computer 12 and an associated user U, a computer network 14, and a network attached storage system D. The computer 12 shown in FIG. 4 typically comprises a processing system 28, and comprises one or more applications 30. The computer 12 is connected to the network 14 through a network connection 24 and a network interface 26, typically a network interface card NIC.

As seen in FIG. 3, a network destination computer 16 is also connected to the network 14, through a network connection 32. Communication between the computer 12 and the network storage computer 16 is typically accomplished through one or more established protocols, such as the TCP protocol for transport services, such as RFC-793, and/or the IP protocol for network services, such as RFC-791.

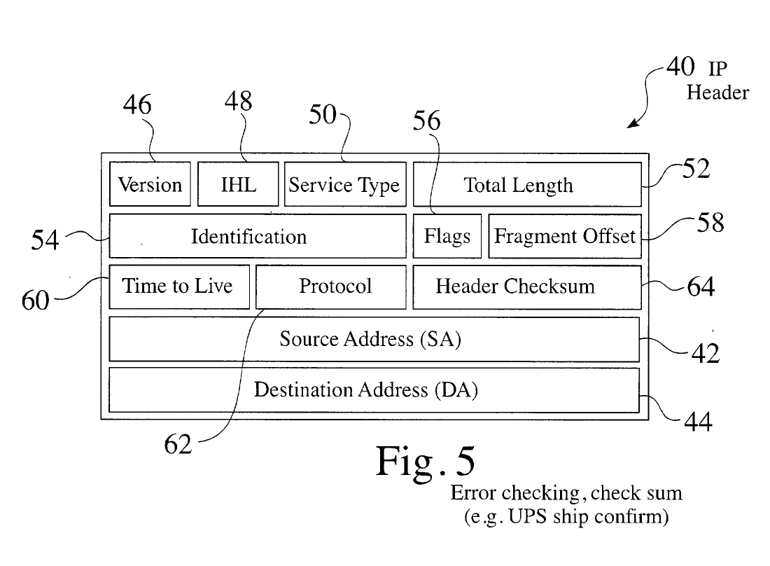

FIG. 5 is a schematic diagram of an IP (Internet Protocol) header 40. The IP header 40 is defined by RFC 791 and typically comprises several fields, including a Source Address 42, a Destination Address 44, a version 46, an IHL 48, a service type 50, a total length 52, an identification 54, flags 56, fragment offset 58, time to live 60, protocol 62, and header checksum 64. The fields of the IP header are examples of elements of the protocol, or protocol elements. In this Specification and in the claims that follow, a protocol element is any field or string of data that is included within received data.

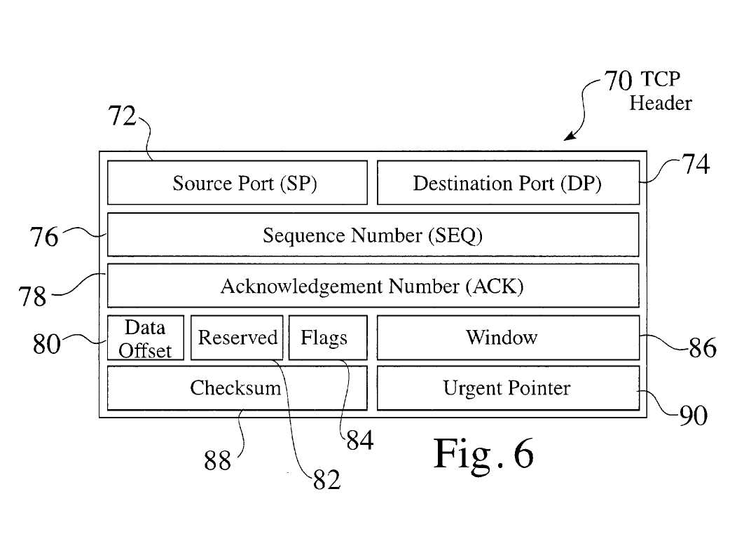

FIG. 6 is a schematic diagram of a TCP (Transmission Control Protocol) header 70. The TCP header is defined in RFC 793. It typically comprises several fields, including a Source Port SP 72, a Destination Port DP 74, a sequence number 76, an acknowledgment number 78, a data offset 80, a reserve field 82, TCP flags 84, a window 86, a checksum 88, and an urgent pointer 90.

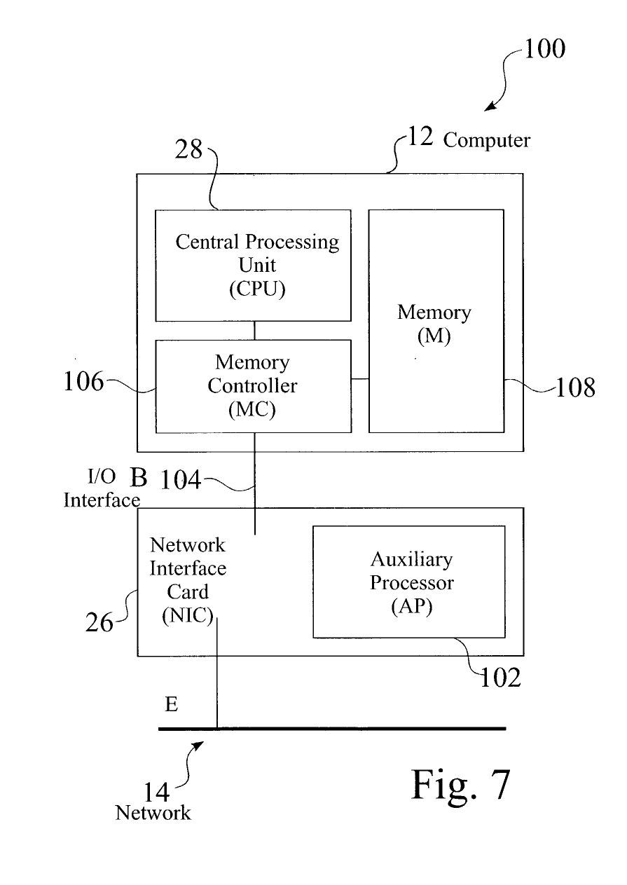

FIG. 7 is an illustration which shows the relationship between the network interface NIC 26, the computer network 14 and other primary components of a computer 12, including the central processor 28, the memory controller 106, and the memory 108. The fields of the TCP header are examples of protocol elements.

As seen in FIG. 7, a computer network 14 is connected to a network interface NIC 26. An auxiliary processor AP 102 is co-located with the network interface NIC 26. A network interface NIC 26 is connected to a computer 12 via an I/O interface 104. The I/O interface 104 is connected to the memory controller 106. A memory controller 106 is connected to the memory 108 and the processor 28 of computer 12.

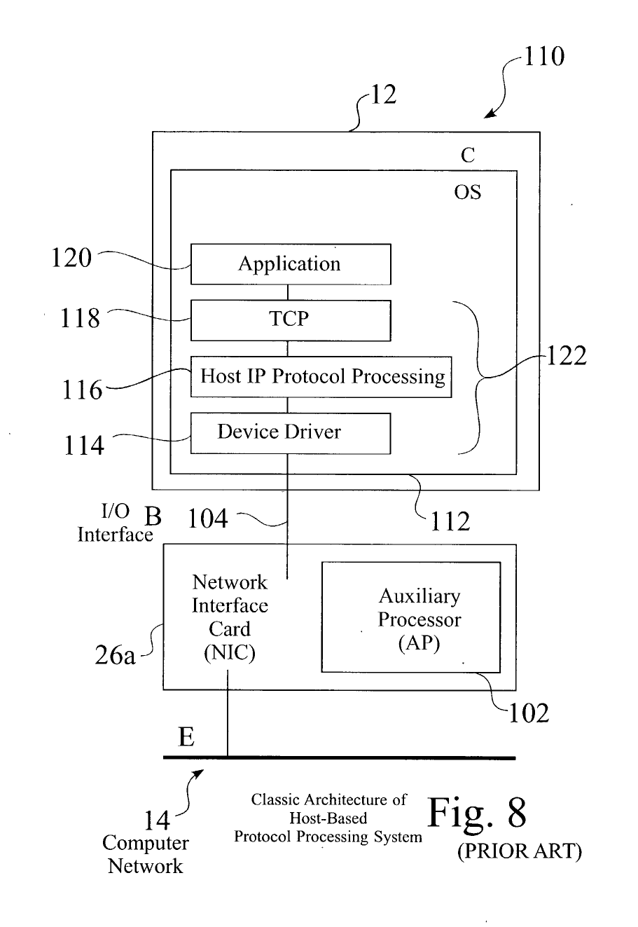

FIG. 8 is a schematic depiction showing the current model of host based protocol processing as it is usually performed in a modem computer 12. A computer network 14 is connected to a network interface 26a, which is connected to a computer 12. Within the operating system 112 of computer 12, a network interface device driver function 114 communicates with the NIC 26, and with an IP protocol processing function 116. The IP protocol processing function 116 communicates with a TCP protocol processing function 118 and the network interface device driver 114. A network application 120 communicates with the TCP protocol processing function 118. Each of the layered functional blocks 122 comprises a network device driver function 114, an IP protocol processing function 116, and TCP protocol processing function 118 has a specific function that it performs for all data that is passed to it by the layers above and below which defines a classical arrangement of host based network protocol processing.

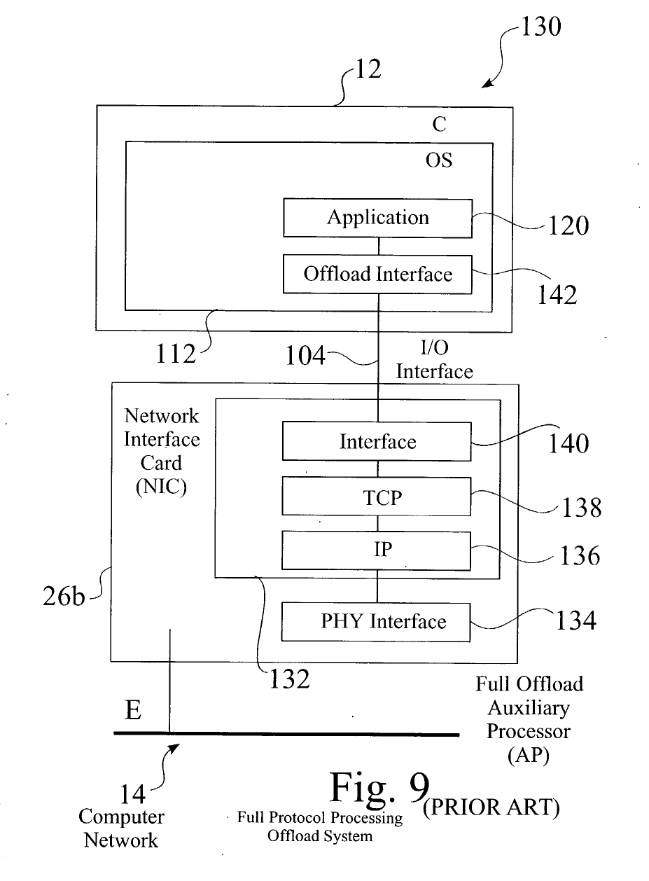

FIG. 9 is a schematic depiction showing the current model of full protocol processing offload to an auxiliary processor 132. A computer network 14 is connected to a full offload network interface NIC 26b. A full offload auxiliary processor 132 is co-located with the full offload network interface NIC 26b. The full offload network interface NIC is connected to a computer 12. Within the full offload auxiliary processor 132, an offload network interface device driver function 134 communicates with the NIC 26b and with an IP protocol processing function 136. The IP protocol processing function 136 communicates with a TCP protocol processing function 138 and the offload network interface device driver function 134. A TCP protocol processing function 138 communicates with the IP protocol processing function 136 and the auxiliary processor resident host offload interface function 140. The auxiliary processor resident host offload interface function 140 communicates with the TCP protocol processing function 138 and the host resident host offload interface function 142. The host resident host offload interface function 142 communicates with the auxiliary processor resident host offload interface function 140 and the network application 120.

As seen in FIG. 9, each layer 114, 116, 118 of the protocol processing stack 122 from FIG. 9 has moved from operating in the host operating system 112 of computer 12 to operating in the full offload auxiliary processor 132 of the network interface 26b. Although the offloading system 130 shown in FIG. 9 accomplishes the desired result of offloading the protocol processing from the host processor 12, it requires that all network functions and requirements be fully implemented in the offloading auxiliary processor 132. When all data communications are functioning normally, the resource requirements, including the buffering of data is relatively small. When network errors and other conditions occur such as dropped or lost packets, the receipt of packets out of sequence, or the receipt of fragmented data, the resources consumed rise dramatically. Specific examples of errors and exceptional conditions that cause an increase in resource utilization include IP reassembly, TCP resequencing, loss of the first packet of a fragmented TCP segment, loss of TCP acknowledgments, loss of a packet containing application framing information, out of order TCP segments where the first TCP segment contains application framing data and other situations where due to the nature of the data that is lost or reordered, some user data must be stored for use later.

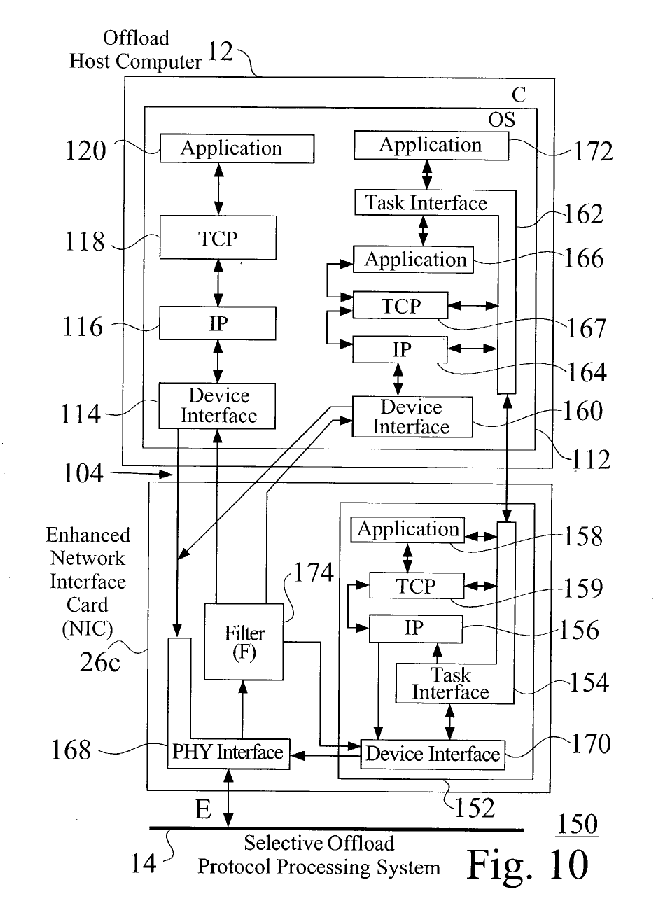

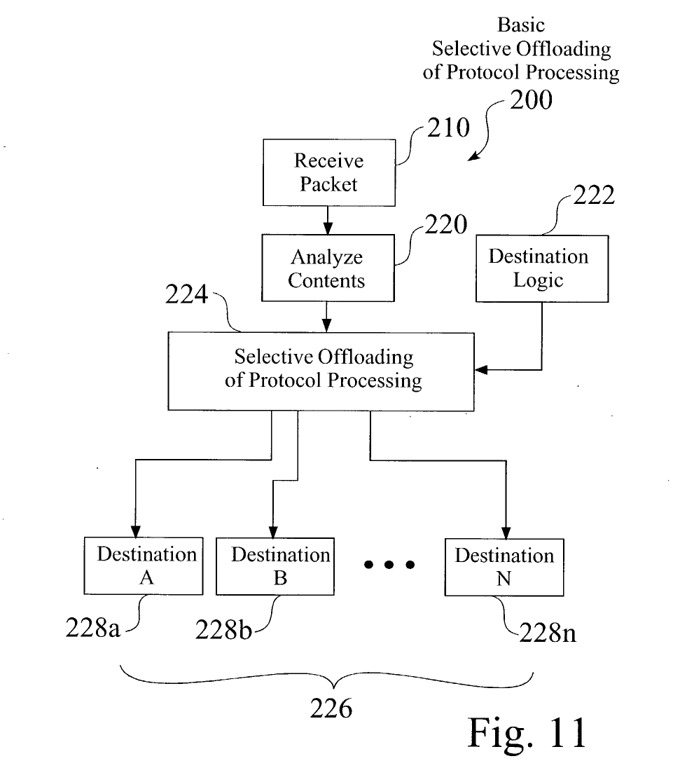

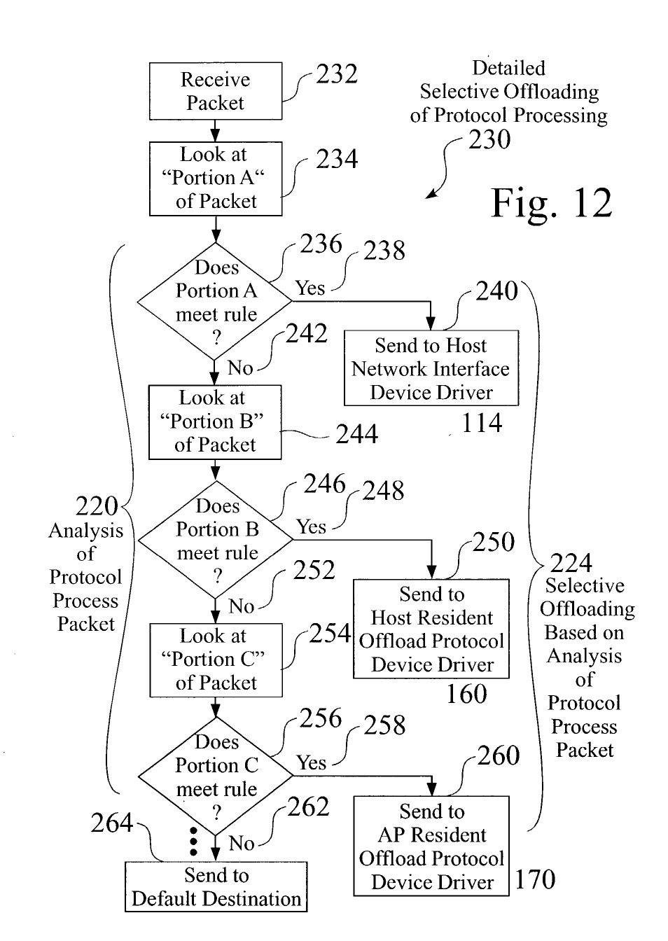

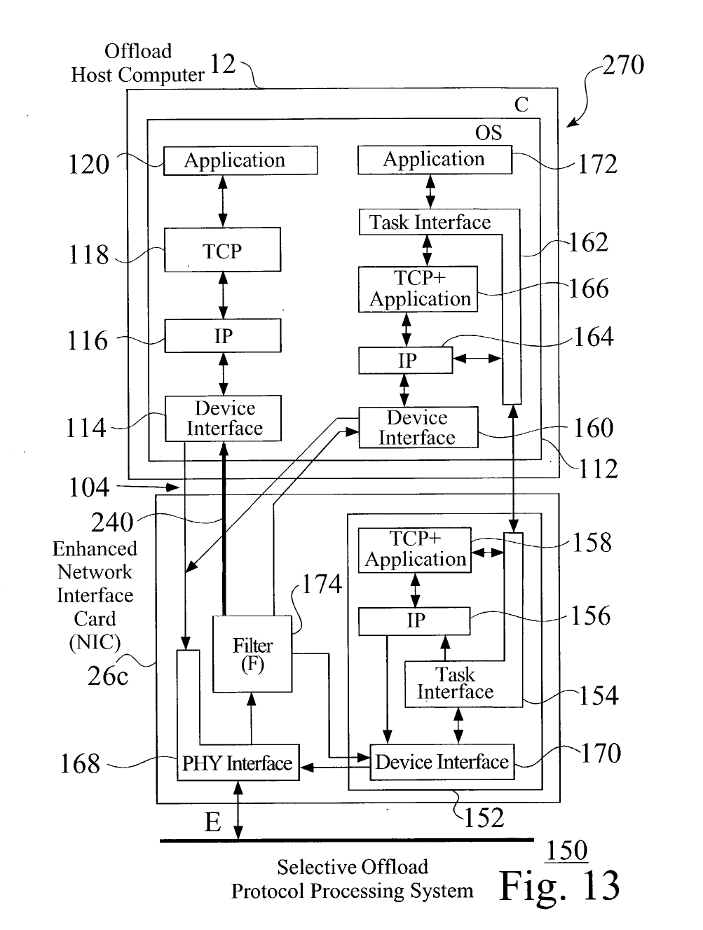

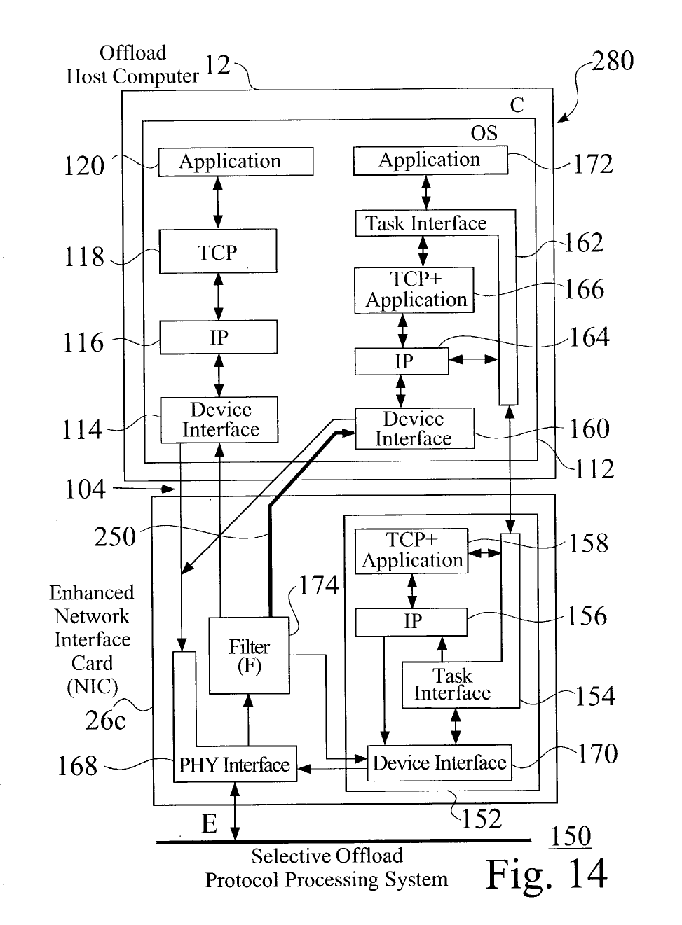

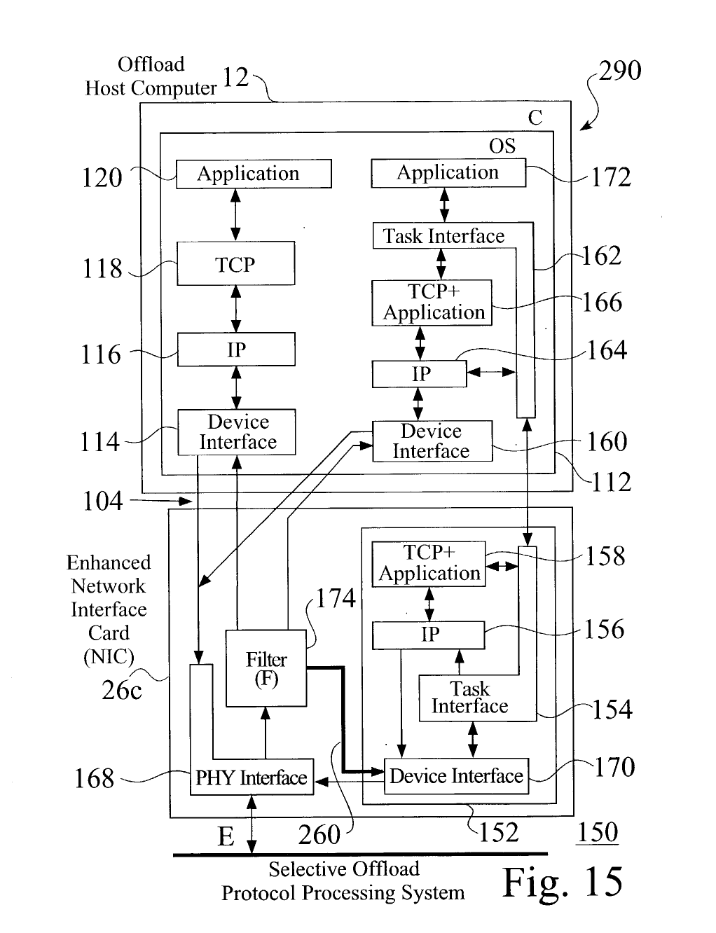

FIG. 10 is a schematic depiction of the present invention 150 which employs a selective offloading auxiliary processor 152. A computer network 14 is connected to a physical interface function 168 of the network interface 26c. A physical interface function 168 receives data from a computer network 14 and sends it to a filtering function 174. A physical interface function 168 receives data to transmit to a computer network 14 from a host network interface device driver function 114, a host resident offload protocol device driver function 160 and an AP resident offload protocol device driver function 170. A filtering function 174 receives inbound data from a physical interface function 168, and selects an appropriate device driver to send the received data to for processing. A filtering function 174 selects between a host network interface device driver function 114, a host resident offload protocol device driver function 160 or an AP resident offload protocol device driver function 170.

A host network interface device driver function 114 sends outbound data to a physical interface function 168 and inbound data to an IP protocol processing function 116. The same host network interface device driver 114 receives inbound data from a filtering function 174 and outbound data from an IP protocol processing function 116. An IP protocol processing function 116 communicates with a TCP protocol processing function 118 and a host network interface device driver 114. A network application 120 communicates with the TCP protocol processing function 118. Processing functions 114, 116, and 118, are the standard, unmodified, host based network protocol processing functions 122 also depicted in FIG. 5.

An AP resident offload protocol stack device driver function 170 sends outbound data to a physical interface function 168 and inbound data to an AP resident offload task interface function 154. The same AP resident offload protocol stack device driver function 170 receives inbound data from a filtering function 174 and outbound data from an AP resident offload task interface function 154 and AP resident IP protocol offload function 156. An AP resident offload task interface function 154 receives inbound data from an AP resident offload protocol stack device driver function 170 and a host resident offload task interface function 162. The same AP resident offload task interface function 154 sends outbound data to an AP resident offload protocol stack device driver function 170 and inbound data to an AP resident IP offload function 156 or a host resident offload task interface function 162. An AP resident IP offload protocol processing function 156 receives inbound data from an AP resident offload task interface function 154 and receives outbound data from an AP resident TCP offload protocol processing function 158. The same AP resident IP offload protocol processing function 156 sends inbound data to an AP resident TCP offload protocol processing function 158 and sends outbound data to an AP resident offload protocol stack device driver function 170. An AP resident TCP offload protocol processing function 158 communicates with an AP resident IP offload protocol processing function 156, an AP resident offload task interface function 154 and an AP resident Application protocol offload processing function 159. An AP resident Application protocol offload processing function 159 communicates with an AP resident TCP protocol offload processing function 158 and an AP resident offload task interface function 154.

A host resident offload protocol stack device driver function 160 sends outbound data to a physical interface function 168 and sends inbound data to the host resident IP protocol offload processing function 164. The same host resident offload protocol stack device driver function 160 receives inbound data from a filtering function 174 and receives outbound data from host resident IP protocol offload processing function 164. A host resident IP protocol offload processing function 164 communicates with a host resident TCP protocol offload processing function 166, a host resident offload protocol stack device driver function 160, and a host resident offload task interface function 162. A host resident TCP protocol offload processing function 166 communicates with a host resident IP protocol offload processing function 164, a host resident offload task interface function 162 and a host resident Application protocol offload processing function 167. A host resident Application protocol offload processing function 167 communicates with a host resident TCP protocol offload processing function 166 and a host resident task interface function 162. A host resident offload task interface function 162 communicates with an AP resident offload task interface function 154, a host resident IP protocol offload processing function 164, a host resident TCP protocol offload processing function 166, a host resident Application protocol offload processing function 167 and the network application 172.

In addition to passing network data between the various functions, protocol state information is passed between the host resident task interface function 162, the host resident Application protocol offload processing function 167, the host resident TCP offload protocol processing function 166 and the host resident IP offload protocol processing function 164. The host resident task interface function 162 is responsible for maintaining the protocol state information in the host. Protocol state information is also passed between the AP resident task interface function 154, the AP resident Application protocol offload protocol processing function 159, the AP resident TCP offload protocol processing function 158 and the AP resident IP offload protocol function 156. The AP resident task interface function 154 is responsible for maintaining the protocol state information in the auxiliary processor 152. Protocol state information is passed between the host computer 12 and the auxiliary processor 152 by the host resident task interface function 162 and the AP resident task interface function 154 respectively.

The protocol service state information includes the task request from the network application 172, state information describing the connection that was previously established and initialized, if the request pertains to a previously established connection and information to support the communications and synchronization between the host resident offload task interface function 162 and the AP resident offload task interface function 154.

Prior inventions have used combinations of the approaches 110, 130 shown in FIGS. 8 and 9. When these are combined directly, each implementation must implement the entire scope of the network protocol. Each implementation must handle all contingencies, errors, corner cases and unusual circumstances. The ability to have a robust host resident protocol stack with an auxiliary processor based offload engine where individual tasks are selected and transferred to the auxiliary processor for completion has been a long strived for goal. Many earlier attempts have tried to shoehorn in the task selection and transfer process into an existing host protocol stack 116, 118. This has proved to be cumbersome, difficult and error prone. The results have not included an effective, robust product.

The novel use of using a parallel host resident protocol processing function that has been designed to facilitate the transfer of protocol processing tasks to and from an auxiliary protocol processor allows the original network protocol processing stack to remain unmodified, fully functional and robust, while enabling a selective protocol processing offload functionality. But this approach only solves part of the problem. The network application may be bound to the correct protocol processing stack, but classically, incoming network data is always demultiplexed in a defined order where the network layer (IP) is handled first, followed by the transport layer (TCP) until finally the data is sent to the application. The application only receives the data after the default, host based network protocol processing stack has processed it, bypassing the offload functionality. This is shown in FIG. 8, where an Ethernet frame is received from the Ethernet media E by the NIC 26 and is passed, unmodified, to the device driver 114. The device driver 114 strips away the Ethernet header and passes the IP packet to the IP protocol processor 116. The IP protocol processor 116 validates the given IP packet and strips off the IP header and passes the resulting TCP segment to the TCP protocol processor 118. The TCP protocol processor 118 validates the given TCP segment and strips off the TCP header. The resulting data is sent to the application. As seen from this description, each protocol processing function is limited in its scope and when receiving network data from the NIC 26, only receives data from the layer below it and sends data to the layer above it. It does not look further into the data. To avoid all of the protocol processing functions being performed by the host protocol stack 116, 118, the NIC 26 must be aware of the existence of multiple sets of protocol processing functions, otherwise known as parallel protocol processing stacks.

In the past, when operating a host based network protocol stack and an offloaded network protocol stack, a separate network address was required to be allocated to the offload protocol stack. This consumes network addresses and forces networking devices that communicate with the offloaded protocol stack to be aware of the existence of the offloaded protocol stack in as much as the communicating devices must address the offload protocol stack directly. This results in an additional administrative overhead where the communicating network devices must be administered to inform them of the address of the offload network protocol stack. For large numbers of network devices in complex data centers, this can be a large job and can slow deployment.

The novel use of a filter 174 within the network interface function to determine which protocol processing function to use allows the transparent introduction of protocol offload processing. The transparency comes from the ability to use the same network address as the host protocol stack 116, 118 and thus does not require that any administrative action be taken to enable the communicating network devices to communicate with an additional network address.

It has been recognized that the benefit of offloading network protocol processing is directly related to the design of the application protocol that is being used. Put simply, some applications will benefit greatly when network protocol offloading is used and some will not.

The novel use of a filter 174 selecting which protocol stack to use on the basis of the application protocol and not solely on the destination media access control (MAC) address or the destination network address of the received network data enables the network protocol offload function to intelligently select which network protocol(s) are offloaded and to which network protocol processing stack the received network data is sent to for processing. This completes the enabling of the selective network protocol offload functionality. Combined with the use of dual host resident network protocol stacks, application aware filtering in the network interface allows a incoming network data to be sent to the standard host based network protocol processing function, the AP resident offload protocol processing function, the host resident offload protocol processing function, or another, application specific protocol processing function.

IV. Methods of Operation of Selective Offload Protocol Processing

In FIG. 3, a network application running on a computer 12 must establish a connection and retrieve data from the network attached storage system 16. To accomplish this, in FIG. 7, network application 172 sends a request to a host resident offload task interface function 162 to open a TCP connection and perform application specific initialization with a network attached storage device 16. Network application 172 is able to make this request using a host resident offload task interface function 162, because the AP and host resident TCP and +Application protocol processing functions 166, 158, 167, 159 are able to offload the network and application protocols that network application 172 uses.

In one preferred embodiment of this invention, the task of establishing a new TCP connection and performing application specific initialization is considered a complex task that should not be offloaded to the auxiliary processor. Once the TCP connection is established, it is then passed to the auxiliary processor so that subsequent data movement operations will be offloaded. A host resident offload task interface function 162 calls a host resident TCP protocol offload processing function 166 with a protocol service request. A protocol service request includes the task request from the network application 172, the information describing the connection, and information to support the communications and synchronization between a host resident offload task interface function 162 and an AP resident offload task interface function 154. The host resident TCP protocol offload processing function 166 performs the requested task, making calls to a host resident IP protocol processing function 164 which, in turn, performs the requested task, making calls to a host resident offload protocol stack device driver function 160. A host resident offload protocol stack device driver function 160 calls a physical interface function 168 and receives data from a filtering function 174. Once the TCP connection has been established, the information describing the TCP connection is transferred from the host resident TCP protocol offload function 166 to the AP resident TCP offload function 158 by the act of the host resident task interface 162 taking the TCP state information and passing this state information to the AP resident task interface 154. The AP resident task interface 154 takes the given TCP state information and passes it to the AP resident TCP protocol offload function 158. Once the state information has been transferred, the AP resident task interface 154 indicates the completion of the state transfer to the host resident task interface 162. A host resident task interface function 162 then notifies a network application 172.

Now that the connection between computer 12 and network attached storage 16 has been established and initialized, network application 172 calls a host resident offload task interface function 162 requesting that data be sent to network attached storage 16.

In one preferred embodiment of this invention, the host resident offload task interface function 162 recognizes that this task is most efficiently accomplished by offloading it to an auxiliary processor 152, and calls an AP resident offload task interface function 154 with a protocol service request. A protocol service request includes the request from the network application 172, the information describing the connection that was previously established and initialized and information to support the communications and synchronization between a host resident offload task interface function 162 and a AP resident offload task interface function 154. An AP resident offload task interface function 154, upon receiving and accepting this request forwards the request to an AP resident Application protocol offload processing function 159. An AP resident Application protocol offload processing function 159 performs the requested task, making calls to an AP resident TCP protocol processing function 158. An AP resident TCP protocol processing function 158 performs its function and calls an AP resident IP protocol processing function 156 which, in turn, performs the requested task, making calls to an AP resident offload protocol device driver function 170. An AP resident offload protocol device driver function 170 calls a physical interface function 168 and receives data from a filtering function 174. Once a task has been completed, an AP resident task interface function 154 notifies a host resident offload task interface function 162, by passing back a protocol service response. A host resident offload task interface function 162 notifies a network application 172.

A network application 172 calls a host resident offload task interface function 162 requesting that a specific piece of data be read from the network attached storage 16.

In one preferred embodiment of this invention, a host resident offload task interface function 162 recognizes that this task is most efficiently accomplished by offloading it to the auxiliary processor 152, and calls an AP resident offload task interface function 154 with the protocol service request. An AP resident offload task interface function 154, upon receiving and accepting this request forwards the request to an AP resident Application protocol offload processing function 158. An AP resident Application protocol offload processing function 158 performs the requested task, making calls to an AP resident TCP protocol processing function 158. An AP resident TCP protocol processing function 158 performs its function and calls an AP resident IP protocol processing function 156 which, in turn, performs the requested task, making calls to an AP resident offload protocol device driver function 170. An AP resident offload protocol device driver function 170 calls a physical interface function 168 and receives data from a filtering function 174. During the execution of the given task by an AP resident TCP protocol offload processing function 158, an AP resident TCP protocol offload processing function 158 detects that some of the data segments have been dropped. A full network protocol stack is required to collect the segments that have been received and acknowledge those up until the first dropped segment. The subsequent segments must be held, unacknowledged, until the missing segment(s) are received. Retaining these segments consume storage resources in the 152. In the case of selective offloading of network protocol processing, an AP resident TCP protocol offload processing function 158 notifies an AP resident task interface function 154 of the loss by passing back a protocol service response for the TCP connection and a protocol service response for the Application task request. An AP resident task interface function 154 notifies a host resident offload task interface function 162, by passing back the protocol service responses. A host resident offload task interface function 162 passes this protocol service responses to a host resident TCP protocol offload processing function 166 and a host resident Application protocol processing function 167 to complete. The error recovery and the remainder of the original task is performed by a host resident Application and TCP protocol offload processing functions 166 and 167. One the task has been completed; the host resident Application protocol offload processing function 166 notifies a host resident offload task interface function 162, by passing back a protocol service response. A host resident offload task interface function 162 then notifies a network application 172. If the given TCP connection is to be reused and the error recovery has been completed, the TCP connection state can again be transferred from the host resident TCP protocol offload function 166 to the AP resident TCP protocol offload processing function 158. This demonstrates how fast path tasks can be easily offloaded to an auxiliary processor, without burdening them with error recovery and exceptional condition processing abilities. Examples of errors and exceptional conditions that should be handled by the host resident portion of the network protocol processing offload functions include IP reassembly, TCP resequencing, lost first packet of a fragmented TCP segment, lost TCP acknowledgments, lost packet containing application framing information, out of order TCP segments where the first TCP segment contains application framing data and other situations where due to the nature of the data that is lost or reordered, some user data must be stored for use later. This greatly reduces the buffering and storage requirements of the auxiliary processor.

In another example a network application 172 calls a host resident offload task interface function 162 requesting that data be sent to network attached storage 16.

In one embodiment of this invention, a host resident offload task interface function 162 recognizes that this task is most efficiently accomplished by offloading it to an auxiliary processor 152, and calls an AP resident offload task interface function 154 with the protocol service request. An AP resident offload task interface function 154 receives the request, but because of a shortage of resources, is unable to execute the requested task. An AP resident offload task interface function 154 notifies a host resident offload task interface function 162, by passing back a protocol service response indicating that the protocol service request was rejected due to lack of resources. The host resident offload task interface function 162, upon receiving a protocol service response indicating a lack of resources, passes the request to a host resident Application protocol offload processing function 167 for execution. This demonstrates how the selective network protocol offload may function in a limited resource environment. Resources that may cause task rejection may include frame buffer space, data frame descriptor space, CPU utilization, task descriptor space, host I/O interface bandwidth, and network interface bandwidth.

V. Methods of Operation of the Selective Offload Filtering Function

As has been shown above, an intelligent filtering function is required to enable the functionality of Selected Offloading of Protocol Processing. The filtering rules that control the operation of a filtering function 174 must be able to be manipulated during the course of operation.

In a preferred embodiment, these filter rule manipulations include the ability to atomically add, delete and modify individual rules.

In an alternative embodiment, these filter rule manipulations only require that an enable bit be atomically settable and resettable, with other functions being non-atomic.

In a preferred embodiment, the size of the rule filter must accommodate the number of active tasks of the given application protocol plus a default rule to match the application and a second default rule for all non-matching traffic.

In an alternate embodiment, a much smaller rule table can be used to differentiate between offloadable application network traffic and non-offloadable network traffic.

In a preferred embodiment, the rules are composed of a plurality of single rules. This plurality of single rules can be combined logically to form a plurality of complex rules. The logical operations used for combining a plurality of single rules into a complex rule include AND, OR, NOT, NAND, and NOR.

In a preferred embodiment, the filtering function must be able to match the desired network address, the desired TCP application protocol number and be able to look into the application headers far enough to filter on the application framing data.

In an alternate embodiment, the filtering function must be able to use protocol elements to match at least on the desired network address and the desired TCP application protocol number.

In another alternate embodiment, the filtering function should be able to use protocol elements to compare the rules against any layer of the ISO reference protocol stack model.

In a preferred embodiment, the filtering function must be able to specify which of a plurality of sets of protocol processing functions should receive and process the received network data.

VI. Apparatus for Selective Offloading of Protocol Processing

In one preferred embodiment, the auxiliary processor function may be constructed using a processor or processors, memory, an interface to the physical network interface and an interface to the host I/O interface. The various auxiliary processor resident functions are implemented in this embodiment as firmware functions that are executed by the processor or processors.

In an alternate preferred embodiment of the auxiliary processor function, some of the repetitive protocol processing functions may be implemented using state machines in hardware in addition to the processor or processors, memory, physical network interface and host I/O interface. The form of this hardware may be gate arrays, programmable array logic (PALs), field programmable gate arrays (FPGAs), Application Specific Integrated Circuits (ASICs), quantum processors, chemical processors or other similar logic platforms. The various auxiliary processor resident functions are implemented in this embodiment as a combination of firmware functions that are executed by the processor or processors and hardware functions that are utilized by the processor or processors.

In another embodiment of the invention, a more highly integrated system may be created by combining computer chips that previously resided on different boards on a single board. Alternatively, functions that previously resided in multiple computer chips may be combined into fewer chips or a single chip. In general, the invention encompasses any method of incorporating selective offloading of protocol processing.

In an alternate preferred embodiment of the auxiliary processor function, the entire auxiliary processor may be implemented using hardware. The various forms of hardware are listed above.

In a preferred embodiment of the network interface NIC, the network interface may be implemented as a card, designed to plug into the host computer's I/O interface such as a Peripheral Component Interconnect (PCI) interface, PCI-X interface or InfiniBand. This may be extended to any wired, wireless or optical interface. An embodiment of this type lets the network interface be installed after the computer has been manufactured.

In an alternate embodiment of the network interface NIC, the network interface may be implemented as a single ASIC which may be mounted on the motherboard of the computer at the time of manufacture.

In an alternate embodiment of the network interface NIC, the network interface may be implemented as a logic component of the I/O subsystem of the host computer. In this embodiment, other logic components may be combined with the offload NIC functionality in a highly complex ASIC.

In an alternate embodiment of the network interface NIC, the network interface may be implemented as a logic component of the memory subsystem of the host computer. In this embodiment, other logic components may be combined with the offload NIC functionality in a highly complex ASIC.

### Conclusion

Although the present invention has been described in detail with reference to particular preferred and alternative embodiments, persons possessing ordinary skill in the art to which this invention pertains will appreciate that various modifications and enhancements may be made without departing from the spirit and scope of the claims that follow. The various hardware and software configurations that have been disclosed above are intended to educate the reader about preferred and alternative embodiments, and are not intended to constrain the limits of the invention or the scope of the claims. The List of Reference Characters which follows is intended to provide the reader with a convenient means of identifying elements of the invention in the Specification and Drawings. This list is not intended to delineate or narrow the scope of the claims.

### Glossary

Auxiliary Processor—The auxiliary processor is any processor or hardware state machine that is not one of the general purpose processors used to perform application processing for a given application. The auxiliary processor is connected in some fashion, either directly or indirectly to the host computer.

Host Computer—This is the computer upon which the application program runs. The computer “hosts” the application and its associated support functions. The host computer is connected in some fashion, either directly or indirectly to the auxiliary processor.

Protocol Stack—A protocol stack is a plurality of protocol processing functions that perform processing for one or more of the protocol layers as defined in the ISO 7 layer reference model. Typically, this includes layer 3 (network) and layer 4 (transport) functions, but may be any set of protocol processing functions.

Host Protocol Stack—The host protocol stack is protocol stack which is a component of the host operating system and is generally provided by the operating system vendor. The host protocol stack resides on a host computer.

Host Resident Protocol Offload Stack—The host resident protocol offload stack is protocol stack which has the ability to selectively offload protocol processing functions to an auxiliary processor. The host resident protocol offload stack resides on a host computer.

Auxiliary Processor Resident Protocol Offload Stack—The auxiliary processor resident protocol offload stack is protocol stack which performs protocol processing functions and offloads these functions from the host computer. The auxiliary processor resident protocol offload stack resides on an auxiliary processor.

Protocol Service Request—The protocol service request is a request made to the auxiliary processor resident offload protocol stack to perform a function on behalf of the host resident offload protocol stack. The protocol service request is accompanied by protocol service state information which fully describes the request.

Protocol Service Response—The protocol service response is a response made to the host resident offload protocol stack by the auxiliary processor resident offload protocol stack informing it of the completion of a protocol service request. The protocol service response is accompanied by protocol service state information which fully describes the response.

Protocol State Information—Protocol state information is the computer data necessary to maintain a network connection by a protocol stack. A protocol stack needs one instance of protocol state information for each network connection.

Protocol Service State Information—Protocol service state information is computer data necessary to fulfill a protocol service request and response. It may contain protocol state information.

Network Connection—A network connection is an established state between two network endpoints utilizing a connection oriented transport protocol. An example of a network connection is a TCP connection.

TCP Connection—A TCP connection is identified by the IP Source Address 42, the IP Destination Address 44, the TCP Source Port 72 and the TCP Destination Port 74. A specific TCP connection may be described and identified by a set of filter rules.

Protocol Elements—Each piece of received network data is composed of protocol elements. A protocol element is any field or string of data that is included within received network data. The protocol elements can be divided into protocol control information and protocol payload information. Within a TCP/IP network, the fields in the IP header (FIG. 5), the fields in the TCP header (FIG. 6) and any other protocol header or payload fields may be considered protocol elements.

Protocol Element Definition—A protocol element definition is a description of a specific instance of a protocol element. An example of a protocol element definition is “the TCP Source Port 72 is 80” or “the IP Source Address 42 is not on the 192.168.21/24 network”.

Filter Rules—A filter rule is a protocol element definition and a protocol stack designator. If the protocol element definition matches the protocol element from the given network data, then the network data is passed to the designated protocol stack. Multiple filter rules may be combined to create complex filters.

### LIST OF REFERENCE CHARACTERS

| | |
|---|---|
| AP | Auxiliary processor |
| B | I/O interface |
| C | Computer |
| CPU | Central processing unit |
| M | Memory |
| MC | Memory controller |
| 14 | Computer network |
| 16 | Network attached storage |
| 18 | Network router |
| 20 | Network switch |
| 26 | Network interface NIC |
| 26a | Standard Network Interface |
| 26b | Full Offload Network Interface |
| 26c | Selective Offload Network Interface |
| 42 | IP Source Address |
| 44 | IP Destination Address |
| 46 | IP Version |
| 48 | IP Header Length |
| 50 | IP Service Type |
| 52 | IP Total Length |
| 54 | IP Identification |
| 56 | IP Flags |
| 58 | IP Fragment Offset |
| 60 | IP Time to Live |
| 62 | IP Protocol |
| 64 | IP Header Checksum |
| 72 | TCP Source Port |
| 74 | TCP Destination Port |
| 76 | TCP Sequence Number |
| 78 | TCP Acknowledgment Number |
| 80 | TCP Data Offset |
| 82 | TCP Reserved |
| 84 | TCP Flags |
| 86 | TCP Window |
| 88 | TCP Checksum |
| 90 | TCP Urgent Pointer |
| 100 | Classic NIC System Architecture |
| 102 | Classic NIC Auxiliary Processor |
| 104 | I/O Interface |
| 106 | Memory Controller |
| 108 | Memory |
| 110 | Host-Based Protocol Processing System |
| 112 | Host Operating System |
| 114 | Host network interface device driver |
| 116 | Host IP protocol processing function |
| 118 | Host TCP protocol processing function |
| 120 | Network application |
| 122 | Protocol Processing Stack |
| 130 | Full Protocol Processing Offload System |
| 132 | Full Offload Auxiliaiy Processor |
| 134 | Auxiliary processor network interface device driver |
| 136 | Auxiliary processor IP protocol processing function |
| 138 | Auxiliary processor TCP protocol processing function |
| 140 | Auxiliary processor side host offload interface |
| 142 | Host side host offload interface |
| 152 | Enhanced Auxiliary Processor |
| 154 | Auxiliary processor resident offload task interface function |
| 156 | Auxiliary processor resident IP protocol offload processing |
| | function |
| 158 | Auxiliary processor resident TCP protocol offload processing |
| | function |
| 159 | Auxiliary processor resident Application protocol offload |
| | processing function |
| 160 | Host resident offload protocol stack device driver function |
| 162 | Host resident offload task interface function |
| 164 | Host resident IP protocol offload processing function |
| 166 | Host resident TCP protocol offload processing function |
| 167 | Host resident Application protocol offload processing function |
| 168 | Physical network interface function |
| 170 | Auxiliary processor resident offload protocol |
| | device driver function |
| 172 | Offload enabled network application |
| 174 | Filtering function |
| 200 | Basic Method for Selective Offloading of Protocol Processing |
| 210 | Packet Receipt |
| 220 | Packet Content Analysis |
| 222 | Processing Destination Logic |
| 224 | Selective Offloading for Protocol Processing |
| 226 | Diversion of Offloaded Protocol Processing |
| 228a- | Protocol Processing Destinations |
| 228n | |
| 230 | Detailed Method for Selective Offloading of Protocol Processing |
| 232 | Packet Receipt |
| 234 | First Packet Portion Analysis |
| 236 | First Packet Portion Decision |
| 238 | First Packet Portion Affirmative Decision |
| 240 | First Packet Portion Affirmative Protocol Routing |
| 242 | First Packet Portion Negative Decision |
| 244 | Second Packet Portion Analysis |
| 246 | Second Packet Portion Decision |
| 248 | Second Packet Portion Affirmative Decision |
| 250 | Second Packet Portion Affirmative Protocol Routing |
| 252 | Second Packet Portion Negative Decision |
| 254 | Third Packet Portion Analysis |
| 256 | Third Packet Portion Decision |
| 258 | Third Packet Portion Affirmative Decision |
| 260 | Third Packet Portion Affirmative Protocol Routing |
| 262 | Third Packet Portion Negative Decision |
| 264 | Third Packet Portion Default Protocol Routing |
| 270 | Selective Offloading of Protocol Processing to Host Interface |
| | Device Driver |
| 280 | Selective Offloading of Protocol Processing to Host Resident |
| | Offload Protocol Device Driver |
| 290 | Selective Offloading of Protocol Processing to AP Resident |
| | Offload Protocol Device Driver |

What is claimed is:

1. A method comprising the steps of:
providing a host computer means for processing a plurality of service requests conveyed over a network;
said host computer means including hardware and software means for fulfilling said plurality of service requests; and
providing an auxiliary processor means for handling protocol processing for said plurality of service requests to free up a portion of said hardware and software means of said host computer means for performing other tasks;
said auxiliary processor means being connected to but generally being separate from said host computer means;
said host computer means also for selectively determining when said auxiliary processor means handles protocol processing for any of said plurality of service requests.

2. A method as recited in claim 1, comprising the additional step of:
providing said auxiliary processor means to said host computer means by placing a separate card within said host computer means.

3. A method as recited in claim 1, comprising the additional step of:
providing said auxiliary processor means to said host computer means by adding a separate chip on a board within said host computer means.

4. A method as recited in claim 1, in which:
said auxiliary processor means offloads the reception of a plurality of iSCSI data over a TCP/IP network protocol.

5. A method as recited in claim 1, in which:
said auxiliary processor means generally performs necessary TCP/IP functions that occur during the normal course of a TCP/IP receive operation, and necessary iSCSI data movement functions.

6. A method as recited in claim 5, in which:
said auxiliary processor means transfers control back to said host computer means to handle the condition in the event of an error.

7. A method as recited in claim 5, in which:
said auxiliary processor means transfers control back to said host computer means to handle the condition in the event of an exceptional condition.

8. A method as recited in claim 1, in which:
said auxiliary processor means generally performs necessary TCP/IP functions that occur during the normal course of a TCP/IP transmit operation, and necessary iSCSI data movement functions.

9. A method as recited in claim 8, in which:
said auxiliary processor means transfers control back to said host computer means to handle the condition in the event of an error.

10. A method as recited in claim 8, in which:
said auxiliary processor means transfers control back to said host computer means to handle the condition in the event of an exceptional condition.

11. A method as recited in claim 1, in which:
said auxiliary processor means offloads a protocol which is among the set of protocols in the seven layer ISO protocol reference model.

12. A method as recited in claim 11, in which:
said protocol which is among the set of protocols in the seven layer ISO protocol reference model has been varied slightly, but which is generally logically consistent with said set of protocols in said seven layer ISO protocol reference model.

13. A method as recited in claim 11, in which:
a plurality of multiple protocols of different layers are taken together, and said auxiliary processor means treats each unique combination of protocols as a separate protocol.

14. An apparatus comprising:
a host computer (12);
a computer network (14); said computer network (14) having a connection to said host computer (12);
a network interface means (26c) for conveying data to and from said host computer (12) and said computer network (14); said network interface means (26c) being connected to but separate from said host computer (12); said network interface means (26c) including
a physical interface means for conveying data (168) to and from said computer network (14);
a filter means (174) for receiving inbound data to transmit to said computer network (14); said filter means (174) being coupled to said physical interface means (168); and
an auxiliary processor means for selective protocol processing (152); said auxiliary processor means (152) being coupled to said filter means (174).

15. An apparatus comprising:
a host computer (12); and
an auxiliary processor (152) coupled to said host computer (12);
a host protocol stack (116, 118); said host protocol stack (116, 118) residing within said host computer (12);
a host resident offload protocol stack (164, 166, 167); said host resident offload protocol stack (164, 166, 167) residing within said host computer (12); and
an auxiliary processor resident offload protocol stack (156, 158, 159); said auxiliary processor resident offload protocol stack (156, 158, 159) residing within said auxiliary processor (152);
a filtering function (174); said filtering function (174) coupled to said auxiliary processor (152); and
said host computer (12) for requesting that a task be performed using said host protocol stack (116, 118);
said host computer (12) also for requesting that a task be performed using said host resident protocol offload stack (164, 166, 167);
said host computer (12) also for requesting that a task be performed using said auxiliary processor resident protocol offload stack (156, 158, 159);
said auxiliary processor (152) for performing offload protocol processing at the request of said host computer (12); and
said auxiliary processor (152) for returning a completion status of said protocol processing task to said host computer (12).

16. An apparatus as recited in claim 15, in which
said host protocol stack (116, 118) includes
a first plurality of protocol processing functions including
a network protocol processing function (116); and
a transport protocol processing function (118) residing on said host computer (12).

17. An apparatus as recited in claim 15, in which
said host resident offload protocol processing stack (164, 166) includes
a second plurality of protocol processing functions including
a host resident network protocol offload processing function (164);
a host resident transport protocol offload processing function (166); and
a host resident application protocol offload processing function (167) residing on said host computer (12).

18. An apparatus as recited in claim 15, in which
said host resident offload protocol processing stack (164, 166, 167) includes
a second plurality of protocol processing functions including
a host resident network protocol offload processing function (164);
a host resident transport protocol offload processing function (166); and
a host resident application protocol offload processing function (167) residing on said host computer (12).

19. An apparatus as recited in claim 15, in which
said auxiliary processor resident offload protocol processing stack (156, 158, 159) includes
an auxiliary processor resident network protocol offload processing function (156);
an auxiliary processor resident transport protocol offload processing function (158); and
an auxiliary processor resident application protocol offload processing function (159) residing on said auxiliary processor (152).

20. An apparatus as recited in claim 15, in which
said auxiliary processor resident offload protocol processing stack (156, 158, 159) includes
an auxiliary processor resident network protocol offload processing function (156);
an auxiliary processor resident transport protocol offload processing function (158); and
an auxiliary processor resident application protocol offload processing function (159) residing on said auxiliary processor (152).

21. An apparatus as recited in claim 15, in which
said filtering function (174) selects a host protocol (116, 118) stack from a plurality of protocol stacks.

22. An apparatus as recited in claim 15, in which
said filtering function (174) selects a host resident offload protocol stack (164, 166, 167) from a plurality of protocol stacks.

23. An apparatus as recited in claim 15, in which
said filtering function (174) selects a auxiliary processor resident offload protocol stack (156, 158, 159) from a plurality of protocol stacks.
